(19) United States
(12) Patent Application Publication
(10) Pub. No.: US 2011/0221775 A1
(43) Pub. Date: Sep. 15, 2011

(54) METHOD FOR TRANSFORMING DISPLAYING IMAGES

(75) Inventor: TENG-YU TSAI, Tu-Cheng (TW)

(73) Assignee: HON HAI PRECISION INDUSTRY CO., LTD., Tu-Cheng (TW)

(21) Appl. No.: 12/904,364

(22) Filed: Oct. 14, 2010

(30) Foreign Application Priority Data
Mar. 10, 2010 (CN) 201010121370.2

(51) Int. Cl. G09G 5/00

(52) U.S. Cl. 345/646

(57) ABSTRACT

A method and an electronic device are used for transforming a first image to a second image on a display of an electronic device. The first image and the second image have same resolution rate. The method includes the following steps. A phase value is acquired from a storage device of the electronic device. A shift proportion value is calculated according to the phase value. The shift proportion value equals to 100 percent divided by the phase value. The first image and the second image are decoded. A series of transition images is generated based on the first image and the second image. The series of transition images includes a first transition image and a second transition image. A plurality of first still pixel values of the first transition images are equal to a plurality of second still pixel values of the second transition images.

### BACKGROUND

1. Technical Field

The present disclosure relates to a method for transforming a first image to a second image on a display.

2. Description of Related Art

Numbers of images stored in an electronic device, such as a digital picture frame, need to be displayed. Typically, some transition effects are performed on a display when an image is switched to another. For example, some applications can realize images fade effect on the display when a displayed image is switched to another. These applications usually store or create a series of images with reduced colors to whole image. When to switch the displayed image, the series of images is displayed in order. However, color of all pixels in each of the images need to be changed, so it is a waste of time to reduce color of all pixels of each image to perform image slide show.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of an electronic device in accordance with an embodiment.

FIG. 2 is another block view of the electronic device of FIG. 1.

FIG. 3 is a flowchart of a method for transforming a first image to the second image in accordance with one embodiment.

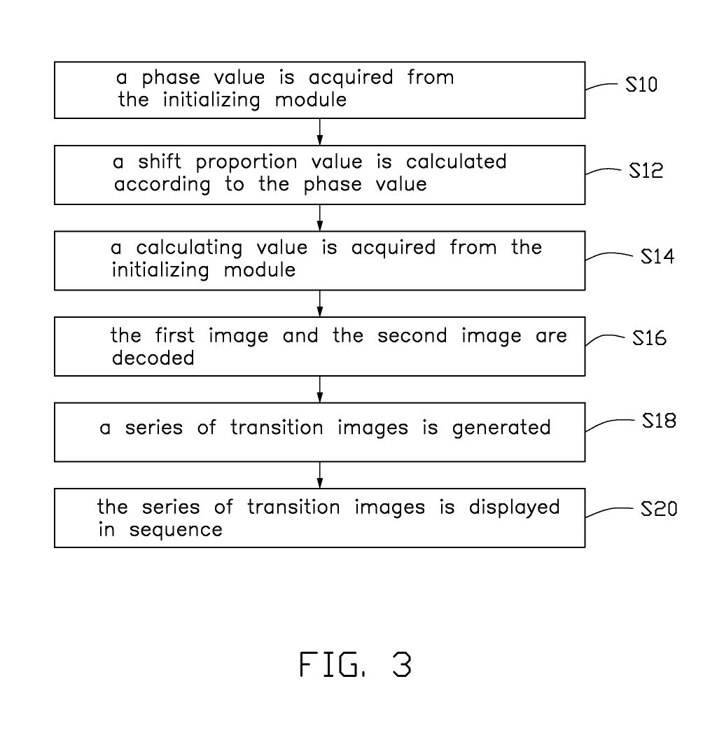

FIG. 4 is a table showing pixel values of a calculating unit of a series of transition images at a calculation state.

FIG. 5 is a table showing pixel values of a calculating unit of a series of transition images at a display state.

FIG. 6 is a table showing pixel values of a calculating unit of a series of transition images at an amendment state.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

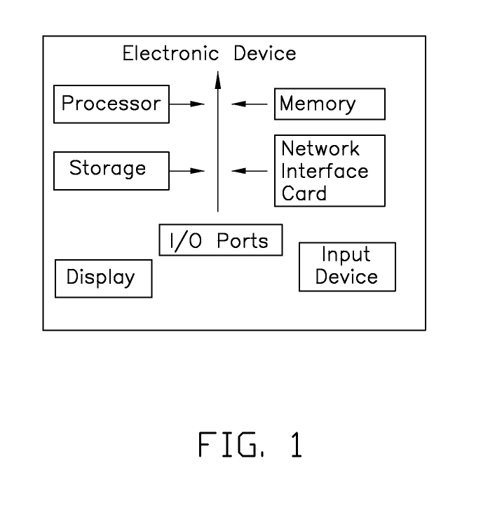

Referring to FIG. 1, an electronic device according to an embodiment may include a processor, a memory, a storage device, a network interface card, at least one I/O port, an input device and a display. A number of images are stored in the storage device.

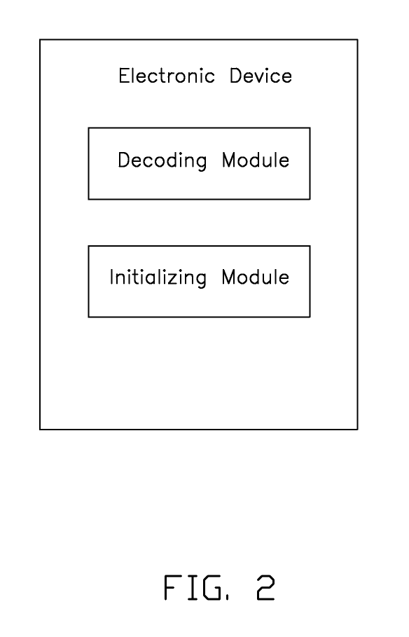

Referring to FIG. 2, the electronic device in one embodiment further includes a decoding module and an initializing module. The decoding module can decode the images in the storage device.

In one embodiment, the electronic device can transform a first image to a second image in a way that the first image is displayed and gradually fade out of the display, and the second image will gradually fade into the display simultaneity. A series of images will be generated in the process. The first image and the second image may have same resolution rate.

A method for transforming the first image to the second image includes the following steps:

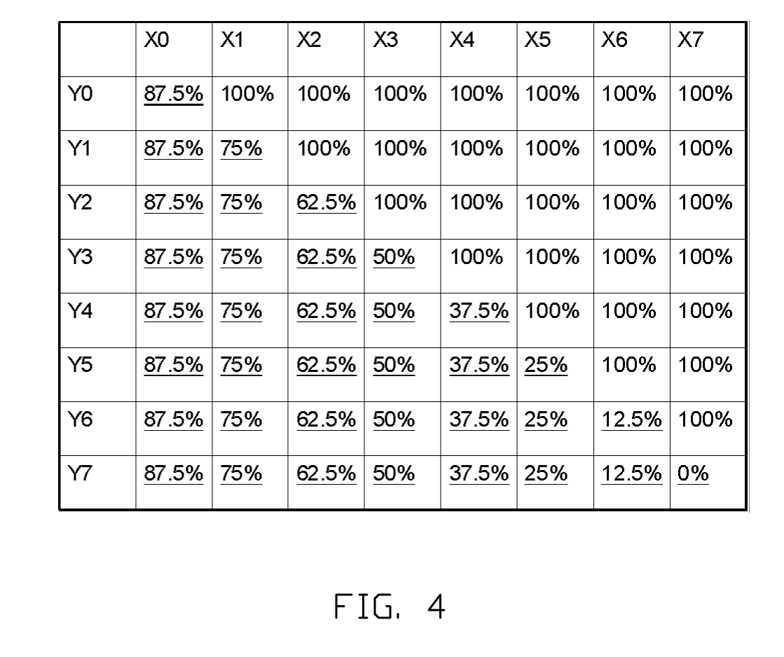

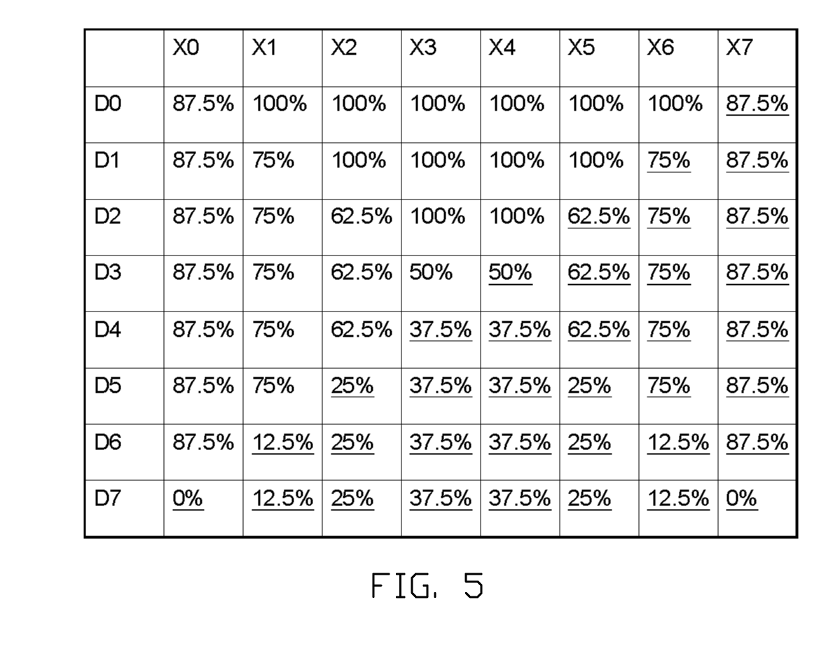

In step 10, a phase value is acquired from the initializing module. The phase value is a number of a series of transition images in the process of the first image converting into the second image. For example, when the phase value is six, six images will be generated in the process for displaying in sequence. The phase value is equal or greater than two. In one embodiment, the phase value is eight. As shown in FIG. 4 and FIG. 5, Y0 to Y7, and D0 to D7 present the transition images. The phase value can be defined by a user through the initializing module or defined by default.

In step 12, a shift proportion value is calculated by the processor according to the phase value. The shift proportion value equals to 100 percent divided by the phase value. In one embodiment, the phase value is eight, the shift proportion value equals to 100 percent divided by eight. The shift proportion value is 12.5 percent.

In step 14, a calculating value is acquired from the initializing module. The calculating value is the number of pixels selected along a vertical direction or horizontal direction of an image. The calculating value may also be defined by user through the initializing module.

In computing, images are displayed by pixels. The pixel is the smallest screen element. It is the smallest unit of image that can be controlled. Each pixel has its own address. The address of a pixel corresponds to its coordinates. Pixels are normally arranged in a two-dimensional grid, and are often represented using dots or squares.

Each of the pixels that represent an image has a pixel value which describes what color it should be. The most common pixel format is the byte image, where this number is stored as an 8-bit integer giving a range of possible values from 0 to 255. Typically zero is taken to be black, and 255 is taken to be white.

Each transition image is divided into a number of calculating units. The calculating value is the number of pixels in each calculating unit of the transition image. In one embodiment, the calculating value is eight. As shown in FIG. 4 and FIG. 5, X0 to X7 are pixels of each calculating unit of each transition image selected along a horizontal direction.

In step 16, the first image and the second image are decoded.

In step 18, a series of transition images is generated according to partial changes of the pixel values from the first image and the second image.

As shown in FIG. 4, a calculating unit of each of the eight transition images (Y0-Y7) is generated. The pixel proportion value occupied by the first image is K. The pixel value in X0 of the first image is V1. The pixel value in X0 of the second image is V2. The pixel value in X0 of Y0 is V. Pixel values of each of the eight transition images are partially changed according to the first image and the second image in the following formula: V=V1*K+V2*(1−K). So we can get a pixel value based on K in X0 of Y0 according to the first image and the second image. K gradually changes from 100 percent to 0 to gradually show fade-out effect of the first image and fade-in effect of the second image.

In arithmetic, in Y0, K(Y0, X0) is reduced by 12.5 percent from 100 percent of the first image, and K in X1 to X7 are unchanged from the first image. In Y1, K(Y1, X0) is copied from K(Y0, X0), K(Y1, X1) is reduced by 12.5 percent from K(Y1, X0), and K in X2 to X7 are unchanged from Y0. In the same way as shown in FIG. 4, K from X0 to X7 in Y3 to Y7 are gradually calculated. In Y7, K decreases from X0 to X7 in arithmetic scale. So eight images (Y0-Y7) are generated in the ROM.

As shown in FIG. 5, eight images (D0-D7) are gradually calculated and displayed on the display one by one. In D0, K(D0, X7) is reduced by 12.5 percent from K(Y0, X7), and K in X0 to X6 are unchanged from the Y0. In D1, K(D1, X6) is reduced by 12.5 percent from K(D0, X7), K in X7 are copied from X0. In D2, K(D2, X5) is reduced by 12.5 percent from K(D1, X6), K in X7 and X6 are copied from X0 and X1 with X7 corresponding to X0 and X6 corresponding to X1. In D3, K(D3, X4) is reduced by 12.5 percent from K(D2, X5), K in X7, X6 and X5 are correspondingly copied from X0, X1 and X2. In D4, K(D4, X3) is reduced by 12.5 percent from K(D3, X4), K in X7, X6, X5 and X4 are correspondingly copied from X0, X1, X2 and X3. In D5, K(D5, X2) is reduced by 12.5 percent from K(D4, X3), K(D5, X3) is copied from the K(D4, X3), and K in X7, X6, X5 and X4 are correspondingly copied from X0, X1, X2 and X3. In D6, K(D6, X1) is reduced by 12.5 percent from K(D5, X2), K(D6, X3) and K(D6, X2) are copied from the K(D5, X3) and K(D5, X2), and K in X7, X6, X5 and X4 are correspondingly copied from X0, X1, X2 and X3. Finally, In D7, K(D7, X0) is reduced by 12.5 percent from K(D6, X1), K(D7, X3), K(D7, X2) and K(D7, X1) are copied from the K(D6, X3) K(D6, X2) and K(D6, X1), and K in X7, X6, X5 and X4 are correspondingly copied from X0, X1, X2 and X3. Eight transition images (D0-D7) are calculated in this way and are displayed on the display one by one.

Referring to FIG. 4 and FIG. 5, transition images based on the table of FIG. 4 may be calculated and stored in the ROM, and the transition images based on the table of FIG. 5 may be shown on the display.

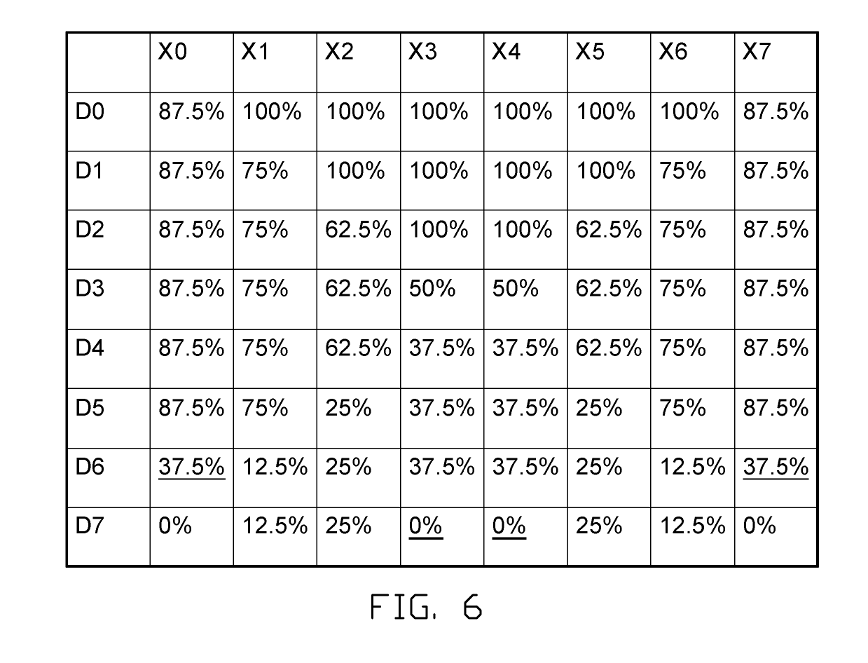

In addition, referring to FIG. 6, some pixel values in the transition images can be adjusted for smoothly displaying the transition images. For example, some sharp pixel values, such as K(D6, X0), K(D6, X7), K(D7, X3) and K(D7, X4) are reduced.

In step 20, the series of transition images is displayed in sequence on the display.

In this method, the transition images are partially changed from the first image and the second image. The second images may fade-in at the same time as the first image fade-out to show the transition effect.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is also to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for transforming a first image to a second image on a display of an electronic device, the first image and the second image having same resolution rate, the method comprising:
acquiring a phase value from a storage device of the electronic device, and calculating a shift proportion value according to the phase value, wherein the shift proportion value equals to 100 percent divided by the phase value;
decoding the first image and the second image;
generating a series of transition images based on the first image and the second image, the series of transition images comprising a first transition image and a second transition image, wherein a number of the series of transition images equals to the phase value, a plurality of first still pixel values of the first transition images are equal to a plurality of second still pixel values of the second transition images, and a plurality of first offset pixel values of the first transition images is not equal to a plurality of second offset pixel values of the second transition images; and
displaying the transition images in sequence.

2. The method of claim 1, wherein the first offset pixel values and the second offset pixel values are equal to sum values of the pixel values of the first image and the second image in different proportions.

3. The method of claim 1, wherein a plurality of calculating units is divided from the first and the second image, and each of the plurality of calculating units comprises a plurality of pixels selected from horizontal direction or vertical direction.

4. The method of claim 3, wherein the plurality of pixels is eight.

5. The method of claim 3, wherein two pixels in each of the plurality of calculating units are changed in one of the series of transition images relative to a previous transition image of the series of transition images.

6. The method of claim 1, wherein the phase value is eight, the series of transition images comprises eight transition images, and the shift proportion value is 12.5 percent.

7. An electronic device for transforming a first image to a second image, the electronic device comprising:
a storage device capable of storing the first image and the second image;
a decoding module capable of decoding the first image and the second image;
a processor capable of being programmed to generate a series of transition images based on the first image and the second image, the series of transition images comprising a first transition image and a second transition image, wherein a number of the series of transition images equals to a phase value, and a plurality of first still pixel values of the first transition images are equal to a plurality of second still pixel values of the second transition images, and a plurality of first offset pixel values of the first transition images are unequal to a plurality of second offset pixel values of the second transition images;
a memory capable of temporarily storing the series of transition images; and
a display capable of displaying the transition images in sequence.

8. The electronic device of claim 7, wherein the first offset pixel values and the second offset pixel values are equal to sum values of the pixel values of the first image and the second image in different proportions.

9. The electronic device of claim 7, wherein each of the first transition image and the second transition image comprises a plurality of calculating units, and each of the plurality of calculating units comprises a plurality of pixels selected from horizontal direction or vertically direction.

10. The electronic device of claim 9, wherein the plurality of pixels is eight.

11. The electronic device of claim 9, wherein only two pixels in each of the plurality of calculating units of the first transition image are not equal to two pixels in each of the plurality of calculating units of the second transition image.

12. The electronic device of claim 7, wherein the phase value is eight, the series of transition images comprises eight transition images, and the shift proportion value is 12.5 percent.

13. A method for transforming a first image to a second image on a display of an electronic device, the first image and the second image having same resolution rate, the method comprising:
providing a storage device, the storage device capable of storing the first image and the second image; providing a decoding module, the decoding module capable of decoding the first image and the second image; providing a processor, the processor capable of being programmed to generate a series of transition images based on the first image and the second image, the series of transition images comprising a first transition image and a second transition image; a memory, the memory capable of temporarily storing the series of transition images; and a display, the display capable of displaying the transition images in sequence;
acquiring the phase value from the storage device, and calculating a shift proportion value according to the phase value, wherein the shift proportion value equals to 100 percent divided by the phase value;
decoding the first image and the second image;
generating the series of transition images based on the first image and the second image; and
displaying the transition images in sequence,
wherein a number of the series of transition images equals to the phase value, a plurality of first still pixel values of the first transition images are equal to a plurality of second still pixel values of the second transition images, and a plurality of first offset pixel values of the first transition images are not equal to a plurality of second offset pixel values of the second transition images.
